(19) United States
(12) Patent Application Publication
(10) Pub. No.: US 2022/0206172 A1
(43) Pub. Date: Jun. 30, 2022

(54) Global Positioning System Encoding On A Data Stream

(71) Applicant: Halliburton Energy Services, Inc., Houston, TX (US)

(72) Inventors: Glenn Andrew Wilson, Houston, TX (US); John Laureto Maida, JR., Houston, TX (US); Andreas Ellmauthaler, Houston, TX (US)

(73) Assignee: Halliburton Energy Services, Inc., Houston, TX (US)

(21) Appl. No.: 17/137,112

(22) Filed: Dec. 29, 2020

(51) Int. Cl. G01V 1/00; G01S 1/70; G02B 6/44; G02F 1/00

(52) U.S. Cl. CPC G01V 1/001; G01S 1/7038; G02F 1/0072; G02B 6/4471; G01S 1/7034

(57) ABSTRACT

A system and method for synchronizing a data stream. The system may include one or more acoustic sources, an information handling system disposed on a platform, a GPS module connected to the information handling system, and a fiber optic cable connected to the information handling system. The method may include transmitting one or more acoustic waves from one or more acoustic sources, sensing the one or more acoustic waves with a fiber optic cable to form a data stream, sending the data stream to an information handling system through the fiber optic cable, communication a time and a location to a GPS module attached to the information handling system with one or more global positioning system (GPS) devices, and modulating the time and the location to the data stream with a fiber optic phase modulator.

### BACKGROUND

Boreholes drilled into subterranean formations may enable recovery of desirable fluids (e.g., hydrocarbons) using a number of different techniques. Identifying the formation and fluid properties may be beneficial to operators. During completion of a well, a fiber optic cable may be temporarily or permanently deployed or conveyed into the wellbore for sensing as part of a distributed acoustic sensing (DAS) system. An acoustic (or seismic) source, disposed on or within the surface, may be activated to propagate acoustic waves into the subterranean formations. The DAS system may detect, measure, and record the acoustic waves as they propagate through the subterranean formation.

Information obtained on the acoustic wave by DAS may be transmitted via optical waveguides, such as optical fibers. For example, in seismological investigations, measurements taken by seismic sensors in response to vibration generated by a seismic source may be transmitted via optical fiber to a recorder for storage, display, analysis, etc. the information and data transmitted is generally not organized and is not synchronized with optically transmitted sensor measurements with the generation of the vibration by the seismic source. Current technology is not able to synchronize optically transmitted signals with any event (for example, stimulation fluid flow, fracture initiation, production fluid flow, seismic events, etc.), and/or to synchronize optically transmitted signals with each other.

### BRIEF DESCRIPTION OF THE DRAWINGS

These drawings illustrate certain aspects of some examples of the present disclosure, and should not be used to limit or define the disclosure.

FIGS. 1A and 1B illustrates an example of a distributed acoustic sensing system operating on a well system;

FIG. 2 illustrates an example well system offshore; and

FIGS. 3A-3D illustrate different examples of a fiber optic cable deployed downhole in a distributed acoustic sensing system.

### DETAILED DESCRIPTION

Provided are systems and methods for time synchronizing data streams with a GPS time source. As discussed below, this may be performed using a pulse train imprinted onto the data stream via fiber stretchers. For example, as discussed below, optical signals are modulated in response to generation of vibration by a seismic source. Another example is described below in which initiation of an event causes an optically transmitted signal to be modulated in synchronization with the initiation of the event. In other examples, optical signals may be synchronized by modulating time-code information on the signals.

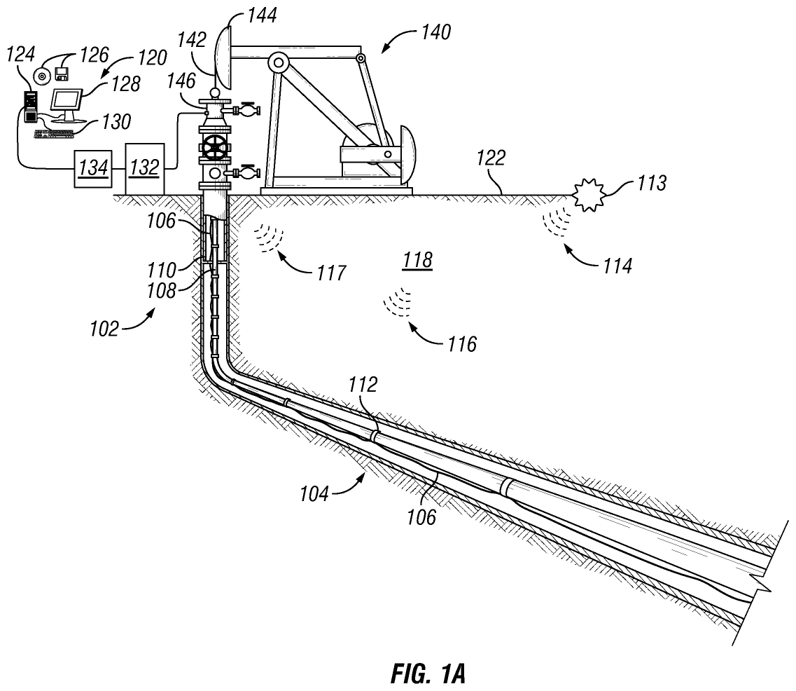

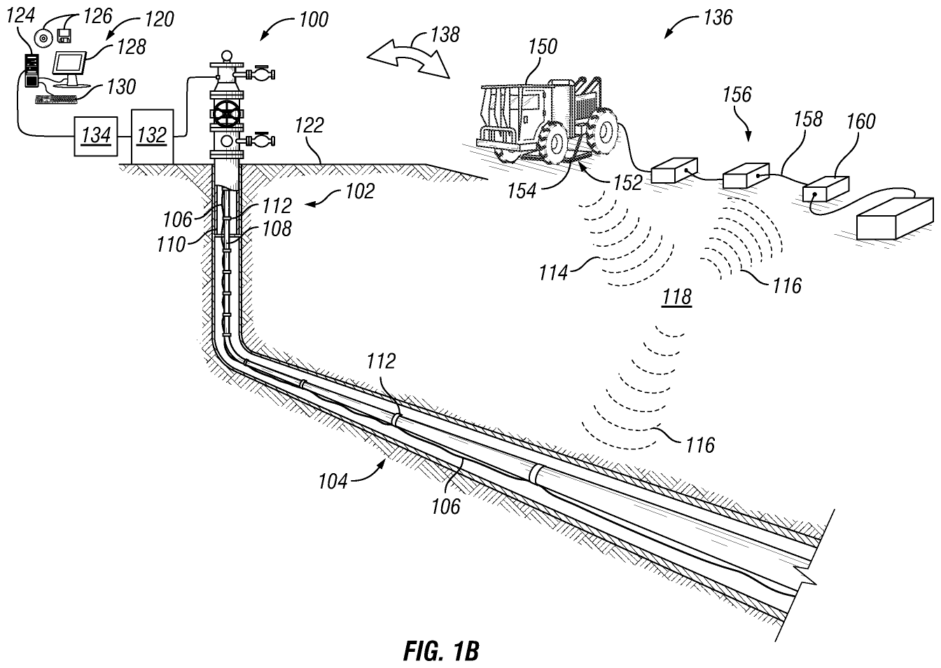

FIG. 1A generally illustrates an example of a well system 100 that may be used in a wellbore 102, which may include a distributed acoustic sensing (“DAS”) system 104. In examples, wellbore 102 may be a steam assisted gravity drainage (SAGD) reservoir, which may be monitored by DAS system 104. It should be noted that well system 100 may be one example of a wide variety of well systems in which the principles of this disclosure may be utilized. Accordingly, it should be understood that the principles of this disclosure may not be limited to any of the details of the depicted well system 100, or the various components thereof, depicted in the drawings or otherwise described herein. For example, it is not necessary in keeping with the principles of this disclosure for completed well system 100 to include a generally vertical wellbore section and/or a generally horizontal wellbore section. Moreover, it is not necessary for formation fluids to be only produced from formation 118 since, in other examples, fluids may be injected into subterranean formation 118, or fluids may be both injected into and produced from subterranean formation 118, without departing from the scope of the disclosure. Additionally, wellbore 102 may be a producing well, an injection well, a recovery well, a monitoring well, and/or an uncompleted well. Further, while FIG. 1 generally depicts onshore systems and operation, those skilled in the art will readily recognize that the principles described herein are equally applicable to offshore systems and operation, without departing from the scope of the disclosure.

In FIG. 1 A, DAS system 104 may be disposed along production tubing 108 and further within casing 110. DAS system 104 may include a fiber optic cable 106. Fiber optic cable 106 may contain single-mode, multi-mode, or a plurality of fiber optic cables. In examples, fiber optic cable 106 may be permanently installed and/or temporarily installed in wellbore 102. Without limitation, DAS system 104 may operate and function to measure a time series of acoustic data. Light may be launched into the fiber optic cable 106 from surface 122 with light returned via the same fiber optic cable 106 detected at the surface 122. DAS system 104 may detect acoustic energy along the fiber optic cable 106 from the backscattered light (e.g., Rayleigh backscattering) returned to the surface 122. For example, measurement of backscattered light may be used to detect the acoustic energy (e.g., acoustic waves 114, or reflected seismic waves 116, and/or unwanted signals deemed to be acoustic noise). In additional examples, Bragg Gratings or other suitable optical or electro-optical devices can be used with the fiber optic cable 106 for the detection of acoustic energy along the fiber optic cable. While FIG. 1A describes DAS system 104 and use of fiber optic cable 106 as the subsurface sensory array for detection of acoustic energy, it should be understood that examples may include other techniques for detection of acoustic energy in wellbore 102. In examples, fiber optic cable 106 may be clamped to production tubing 108. However, fiber optic cable 106 may be clamped to production tubing through connection device 112 by any suitable means. It should be noted that fiber optic cable 106 may also be cemented in place within casing 110 and/or attached to casing 110 by any suitable means. Additionally, fiber optic cable 106 may be attached to a conveyance. A conveyance may include any suitable means for providing mechanical conveyance for fiber optic cable 106, including, but not limited to coiled tubing, wireline, slickline, pipe, drill pipe, or the like. In some embodiments, the conveyance may provide mechanical suspension, as well as electrical connectivity, for fiber optic cable 106. The conveyance may comprise, in some instances, a plurality of electrical conductors extending from surface 122. The conveyance may comprise an inner core of one or a plurality of electrical conductors covered by an insulating wrap. An inner and outer steel armor sheath may be wrapped in a helix in opposite directions around the one or more conductors. At least one electrical conductor may be used for communicating power and telemetry from a downhole tool to surface 122. Information from fiber optic cable 106 may be gathered and/or processed by information handling system 120, discussed below. For example, signals recorded by fiber optic cable 106 may be stored on memory and then processed by information handling system 120. The processing may be performed real-time during data acquisition or after recovery of fiber optic cable 106. Processing may alternatively occur downhole or may occur both downhole and at surface. In some embodiments, signals recorded by fiber optic cable 106 may be conducted to information handling system 120 by way of the conveyance. Information handling system 120 may process the signals, and the information contained therein may be displayed for an operator to observe and stored for future processing and reference. Without limitation, fiber optic cable 106 may be attached to coil tubing and/or the conveyance by any suitable means. Coil tubing and the conveyance may be disposed within production tubing 108 and/or wellbore 102 by any suitable means.

With continued reference to FIG. 1A, DAS system 104 may function and operate to sense acoustic data for measuring acoustic waves 114 and/or reflected seismic waves 116. Acoustic waves 114 and/or reflected seismic waves 116 may illuminate elements (not illustrated) in subterranean formation 118. In examples, acoustic waves 114 may originate from a land based acoustic source 113. Land based acoustic source 113 may be permanently installed device disposed on surface 122 or within subterranean formation 118. As illustrated, land based acoustic source 113 may be an explosion. Additionally, land based acoustic source 113 may be mechanical in nature. As discussed below, land based acoustic source 113 may attach to a vehicle or be a separate standalone device. In such embodiments land based acoustic source 113 may be a piston plate which may oscillate to create acoustic waves 114.

Acoustic waves 114 and/or reflected seismic waves 116 may induce a dynamic strain signal in fiber optic cable 106, which may be recorded by DAS system 104. Alternatively, measurement devices (not shown) may record acoustic waves 114 and/or reflected seismic waves 116 and may transmit information to information handling system 120. Measuring dynamic strain in fiber optic cable 106 may include a strain measurement, a strain rate measurement, fiber curvature measurement, fiber temperature measurement, and/or energy of backscattered light measurement. A strain measurement may be performed by an operation of Brillouin scattering (via Brillouin Optical Time-Domain Reflectometry, BOTDR, or Brillouin Optical Time-Domain Analysis, BOTDA), or Rayleigh scattering utilizing Optical Frequency Domain Reflectometry (OFDR). A fiber curvature measurement may be performed using Polarization Optical Time Domain Reflectometry (P-OTDR) or Polarization-Optical Frequency Domain Reflectometry (P-OFDR). A fiber temperature measurement may be performed utilizing Raman distributed temperature sensing (DTS). An energy of backscattered light of DAS measurement may be performed utilizing an automatic thresholding scheme, the fiber end is set to the DAS channel for which the backscattered light energy flat lines. The purpose of all these measurements may be to compute the structure and properties of formation 118 at different times, including formation and fluid properties. This may allow an operator to perform reservoir imaging and/or monitoring.

Information handling system 120 may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, an information handling system 120 may be a personal computer, a network storage device, or any other suitable device and may vary in size, shape, performance, functionality, and price. Information handling system 120 may include random access memory (RAM), one or more processing resources such as a central processing unit 124 (CPU) or hardware or software control logic, ROM, and/or other types of nonvolatile memory. Additional components of the information handling system 120 may include non-transitory computer-readable media 126, output devices 128, such as a video display, and one or more network ports for communication with external devices as well as an input device 130 (e.g., keyboard, mouse, etc.). Information handling system 120 may also include one or more buses operable to transmit communications between the various hardware components.

Alternatively, systems and methods of the present disclosure may be implemented, at least in part, with non-transitory computer-readable media. Non-transitory computer-readable media may include any instrumentality or aggregation of instrumentalities that may retain data and/or instructions for a period of time. Non-transitory computer-readable media may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing.

Information handling system 120 may further include a single mode-multimode (“SM-MM”) converter 132 and a DAS interrogator 134. SM-MM converter 132 may be used to convert the optical transmission path between one or more single-mode fibers used in the DAS interrogator and multi-mode fibers deployed in the wellbore. DAS interrogator 134 may be used to translate light pulses to digital information, which may be read by information handling system 120. In examples, information handling system 120 may communicate with DAS interrogator 134 and act as a data processing system that analyzes measured and/or collected information. This processing may occur at surface 122 in real-time. Alternatively, the processing may occur at surface 122 and/or at another location. In examples, information handling system 120 may interface with the acoustic source to measure and record auxiliary signals of the acoustic source, including but not limited to time (e.g., GPS time), time break, vibration sweep, ground force, and/or pressure.

Further illustrated in FIG. 1A is a standard surface pumping jack 140, which may be installed at a surface 122 of wellbore 102. A steel cable or bridle 142 may extend from a horsehead 144 of pumping jack 140. Bridle 142 may be coupled to a polished rod (not illustrated), disposed in production tubing 108, by a standard carrier bar (not illustrated). At a position further down-hole, a polished rod (not illustrated) may be coupled with a sucker rod (not illustrated), both disposed in production tubing 108. In one example of the present invention, the sucker rod may include steel rods that are screwed together to form a continuous “string” that connects the sucker rod pump inside of production tubing 108 to pumping jack 140.

A stuffing box 146 may be provided at the top of production tubing 108 in order to seal the interior of production tubing 108 and prevent foreign matter from entering. Stuffing box 146 may be a packing gland or chamber to hold packing material (not shown) compressed around a moving pump rod or polished rod to prevent the escape of gas and/or liquid. The polished rod may provide a smooth transition at stuffing box 146 and may allow for the polished rod to operate in an upward and downward motion without displacing stuffing box 146 or production tubing 108.

The movement of at least the sucker rod in production tubing 108 may produce acoustic noise 117. Without limitation, cultural (or environmental) noises, vibration from wellbore flow, a mechanical device, artificial lift from mechanical devices, an electromechanical device, a surface facility, cultural noise (i.e., naturally occurring noise), and/or industrial facilities may produce acoustic noise 117. In examples, acoustic noise 117 may contaminate acoustic data recorded by DAS system 104. Removing acoustic noise 117 from the measurements may improve signal-to-noise ratio for subsequent modeling, imaging, and/or tomography. Additionally, acoustic noise 117 may only increase in high rate wells, which may further contaminate acoustic data.

FIG. 1B illustrates a surface measuring system 136 may provide accurate near-surface velocity determination. Operating and functioning together, surface measuring system 136 and DAS system 104 may both provide measurements that may be processed by information handling system 120 to analyze time-lapse seismic tomography for time-lapse VSP acquisition in reservoir monitoring. Further, information handling system 120 may be used for time-lapse reservoir monitoring. Reservoir monitoring may be performed through a plurality of surveys over a period of time by surface measuring system 136 and DAS system 104. Depending on the point in time in which a survey is conducted, information handling system 120 may be able to correct the travel time and/or velocity model of each seismic wave at depths near surface 122. This may allow for accurate time-lapse seismic tomography analysis.

It should be noted that information handling system 120 may be connected to DAS system 104 and/or surface measuring system 136. Without limitation, information handling system 120 may be a hard connection or a wireless connection 138. Information handling system 120 may record and/or process measurements from DAS system 104 and/or surface measuring system 136 individual and/or at the same time.

Surface measuring system 136 may include a vehicle 150 and surface sensor array 156. As illustrated, vehicle 150 may include a mechanical acoustic source 152. Mechanical acoustic source 152 may be used to propagate acoustic waves 114 into subterranean formations 118. Without limitations, mechanical acoustic source 152 may be a compressional source or a shear source. In examples, mechanical acoustic source 152 may a truck-mounted seismic vibrator. Mechanical acoustic source 152 may include a baseplate 154 that may be lowered so as to be in contact with the ground. Vibrations of controlled and varying frequency may be imparted to the ground through baseplate 154. When the survey is completed, baseplate 154 may be raised, which may allow mechanical acoustic source 152 and vehicle 150 to move to another location.

In examples, surface sensor array 156 may be coupled to vehicle 150 and towed behind vehicle 150. In examples, an information handling system (not illustrated) may be disposed on vehicle 150. Surface sensor array 156 may serve to detect and record data provided by reflected seismic waves 116 (i.e., refracted seismic energy or one-way seismic tomography) and/or acoustic waves 114 produced by mechanical acoustic source 152. Without limitations, surface sensor array 156 may include of a communication line 158 and sensors 160. As illustrated, the sensors 160 may be spaced behind the vehicle 150. Without limitation, sensors 160 may be geophones, hydrophones, MEMS accelerometers, and/or combinations thereof. In examples, communication line 158 may include a fiber optic cable. The fiber optic cable may be single-mode, multi-mode, and/or combinations thereof. In other examples, surface sensor array 156 may include a plurality of sensors 160 disposed along communication line 158 of surface sensor array 156. It should be noted that the plurality of sensors 160 may be disposed at a fixed location along sensor array 156 and with a pre-determined spacing. Without limitations, the plurality of sensors 160 may be disposed in series, parallel, and/or combinations thereof within surface sensor array 156. The plurality of sensors 160 may be disposed in individual containers and/or durable enough to travel along surface 122.

During measurement operations, information handling system 120 may take into account reflected seismic waves 116 to produce a VSP. In one example, the seismic refraction data may be processed into a near-surface velocity model. Information handling system 120 may update the near-surface velocity model for seismic tomographic reconstruction (i.e., either travel time or wavelength). Further, information handling system 120 may update the travel time used for travel time tomographic reconstruction of the near-surface velocity model. In examples, the seismic refraction data and the seismic tomography data may be simultaneously inverted in the same near-surface velocity model. This information may be used for reservoir monitoring over any length of time.

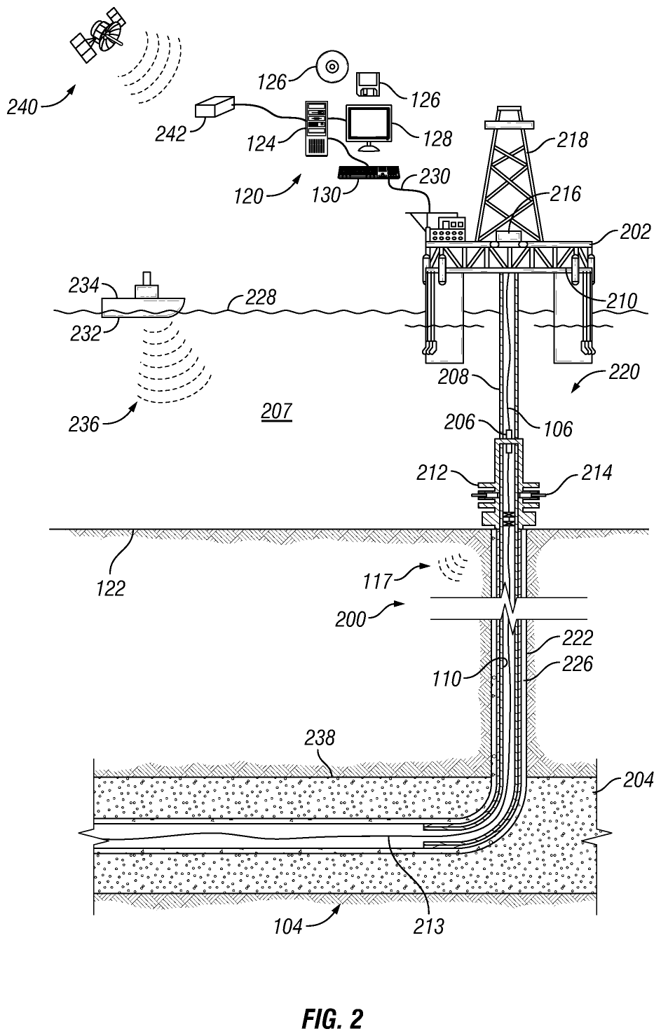

FIG. 2 illustrates an example of a well system 200 operating from a platform 202 in a subsea operation. Platform 202 may be centered over a subterranean formation 204 located below surface 122 of a body of water 207. A conduit 208 may extend from deck 210 of platform 202 to wellhead installation 212 including blow-out preventers 214. Platform 202 may have a hoisting apparatus 216 and a derrick 218 for raising and lowering tubular strings. Additionally, fiber optic cable 106 may traverse through conduit 208 and connect to fiber connection 206 at one end of fiber connection 206. A downhole fiber 213 may connect to the opposite end of fiber connection 206 and traverse trough casing 110 and wellbore 102.

A wellbore 102 may extend through the various earth strata including subterranean formation 204. While well system 200 is shown disposed in a horizontal section of wellbore 102, wellbore 102 may include horizontal, vertical, slanted, curved, and other types of wellbore geometries and orientations in which well system 200 may be disposed, as will be appreciated by those of ordinary skill in the an. Casing 110 may be cemented within wellbore 102 by cement 226.

In examples, a DAS system 104, compatible for offshore applications may be used to measure subterranean formations near well system 200. In examples, during subsea operations, an acoustic source may be generated in many ways. For example, through air burst, transducer type devices, vibrators, and/or the like. As illustrated, these water suitable acoustic sources are identified as acoustic source 232 may be towed behind a boat 234 that may travel along the surface 228 of body of water 207. Alternatively, acoustic source 232 may be disposed below or within body of water 207 at surface 122 as a node (not illustrated). In another example, acoustic source 232 may be disposed and actuated downhole within wellbore 102. In operations there may be a plurality of boats 234 that each have their own acoustic source 232, which is fired in sync or out of sync with other boats.

Acoustic source 232 may be actuated to produce acoustic waves 236 which may travel down towards and interact with subterranean formation 204. Acoustic waves 236 may reflect off formation 204 as reflected seismic waves 116. Reflected seismic waves 116 may be recorded and measured by fiber optic cable 106. Measurements and data recorded from acoustic waves or reflected seismic waves 116 may be transmitted uphole to information handling system 120 for further processing. As discussed above, movement of downhole devices within conduit 208 may produce acoustic noise 117. Without limitation, water movement, marine animals, vibration from wellbore flow, artificial lift, and/or industrial facilities may produce acoustic noise 117. As in FIG. 2, acoustic noise 117 may contaminate acoustic data recorded by DAS system 104. Removing acoustic noise 117 from the measurements may improve signal-to-noise ratio for subsequent modeling, imaging, and/or tomography.

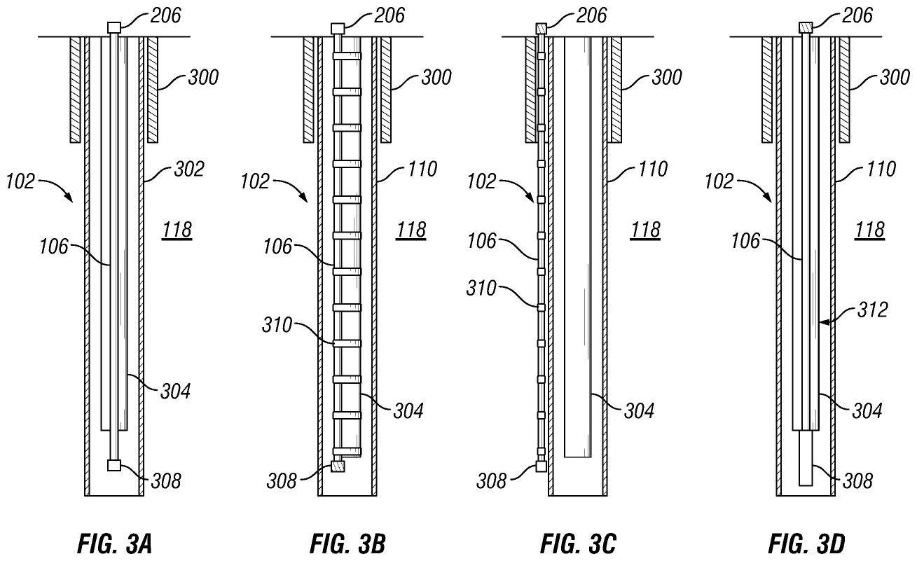

FIGS. 1 and 2 illustrate an example of DAS system 104 deployed for measurement operations. FIGS. 3A-3D illustrate examples of different types of deployment of fiber optic cable 106 in wellbore 102 (e.g., referring to FIGS. 1 and 2). In examples, fiber optic cable 106 may be permanently deployed in wellbore 102 via single- or dual-trip completion strings, behind casing, on tubing, or in pumped down installations. Additionally, fiber optic cable 106 may be temporarily deployed via coiled tubing, wireline, slickline, or disposable cables. As illustrated in FIG. 3A, wellbore 102 deployed in formation 118 may include surface casing 300 in which production casing 110 may be deployed. Additionally, production tubing 304 may be deployed within production casing 110. In this example, of fiber optic cable 106 may be temporarily deployed in a wireline system in which a downhole tool 308 is connected to the distal end of fiber optic cable 106. Further illustrated, of fiber optic cable 106 may be coupled to a fiber connection 206. Fiber connection 206 may operate with an optical feedthrough system (itself comprising a series of wet- and dry-mate optical connectors) in the wellhead that may optically couple fiber optic cable 106 from the tubing hanger to a wellhead instrument panel.

FIG. 3B illustrates an example of permanent deployment of fiber optic cable 106. As illustrated in wellbore 102 deployed in formation 118 may include surface casing 300 in which production casing 110 may be deployed. Additionally, production tubing 304 may be deployed within production casing 110. In examples, fiber optic cable 106 is attached to the outside of production tubing 304 by one or more cross-coupling protectors 310. Without limitation, cross-coupling protectors 310 may be evenly spaced and may be disposed on every other joint of production tubing 304. Further illustrated, fiber optic cable 106 may be coupled to fiber connection 206 at one end and a downhole tool 308 at the opposite end.

FIG. 3C illustrates an example of permanent deployment of fiber optic cable 106. As illustrated in wellbore 102 deployed in formation 118 may include surface casing 300 in which production casing 110 may be deployed. Additionally, production tubing 304 may be deployed within production casing 110. In examples, fiber optic cable 106 is attached to the outside of production casing 110 by one or more cross-coupling protectors 310. Without limitation, cross-coupling protectors 310 may be evenly spaced and may be disposed on every other joint of production tubing 304. Further illustrated, fiber optic cable 106 may be coupled to fiber connection 206 at one end and a downhole tool 308 at the opposite end.

FIG. 3D illustrates an example of a coiled tubing operation in which fiber optic cable 106 may be deployed temporarily. As illustrated in FIG. 3D, wellbore 102 deployed in formation 118 may include surface casing 110 in which production casing 110 may be deployed. Additionally, coiled tubing 312 may be deployed within production casing 110. In this example, fiber optic cable 106 may be temporarily deployed in a coiled tubing system in which a downhole tool 308 is connected to the distal end of downhole fiber. Further illustrated, fiber optic cable 106 may be attached to coiled tubing 312, which may move fiber optic cable 106 through production casing 110. Further illustrated, fiber optic cable 106 may be coupled to fiber connection 206 at one end and downhole tool 308 at the opposite end.

Referring back to FIGS. 1 and 2, systems and methods within this disclosure may be implemented, at least in part, with information handling system 120. As previously described, information handling system 120 may communicate with DAS system 104 and act as a data processing system that analyzes acoustic data. This processing may occur above surface 122 on platform 202 in real-time. Alternatively, the processing may occur above surface 122 and/or at another location. Without limitations, DAS system 104 may be connected to and/or controlled by information handling system 120. In examples, a communication link 230 may be provided which may transmit data from DAS system 104 to information handling system 120 on platform 202. Without limitations, the communication link may be wired and/or wireless. Information handling system 120 may include a processing unit 124, output device 128, an input device 130 (e.g., keyboard, mouse, etc.), and/or non-transitory computer-readable media 126 (e.g., optical disks, magnetic disks) that may store code representative of the methods described herein.

As illustrated in FIG. 2, there may be multiple acoustic sources 232 that are emitting acoustic waves 236 in sync or out of sync. This makes it difficult to determine at what time a specific acoustic source 232 was used and where the information was obtained in a data stream. Data transmitted by DAS system 104 is considered a data stream. The data stream may be transmitted up and down fiber optic cable 106 and to information handling system 120. In examples, information handling system 120 may also be connected to a Global Positioning System (GPS) 240 through a GPS module 242, which may operate like a receiver connected to information handling system 120, that may communicate with GPS 240, where GP 240 is any suitable device such as one or more satellites. As illustrated, GPS module 242 may act as a time-code generator, which may allow the data stream to be synchronously modulated with time signals from GPS 240 using GPS module 242. For example, for continuous measurements where an event may not be planned in advance, which may be found in subsea operations, but time synchronization of measurement data is important, a time-code signal may be encoded into the data stream. Current technology time-codes the data stream after processing the data stream. This leads to errors in timing alignment between seismic event data and an actual synchronous time stamp. To overcome this issue, the data stream using GPS module 242 is time synchronized with a time source, such as GPS 240, using a pulse train imprinted onto the data stream via fiber optic phase modulators, such as piezoelectric crystal-based fiber optic stretchers, where the position of the rising edge of each pulse corresponds to the precise beginning of a new second. Piezoelectric fiber stretchers may be designed to induce up many radians of interferometric phase change per volt of applied potential with good linearity to tens of kHz modulation bandwidth. A method on how to detect these pulses in the DAS data stream either in real-time or during post-processing, and how to obtain the precise GPS time for each DAS sample by simply interpolating between two consecutive pulses.

As discussed above, the electrical output of GPS module 242 may be used by DAS system 104 to modulate the optical signals transmitted via fiber optic cable 106, based on an encoding method, such as, SMPTE linear time codes used in audio applications. When multiple monitoring systems are deployed within a study region, for example with multiple DAS systems 104 and multiple acoustic sources 232, the resulting synchronization will allow for unified processing of seismic wave fields recorded on these systems. Unified processing would result in improved source-location accuracy, as well as increased system sensitivity. During operations, multiple DAS systems 104 each with a GPS module 242 may be used, where each GPS module 242 is in communication with one or more GPS 240 devices. Utilizing multiple GPS modules 242 is that unique location information may also (in addition to synchronized time information) be modulated on the optical signals transmitted via fiber optic cable 106. In this manner, the locations of each of fiber optic cable 106 may be recorded, along with synchronized time-code information.

Measurements taken by DAS system 104 on a data stream are synchronously modulated with time signals from GPS 240. In the example discussed above with multiple acoustic sources 232, a data stream is blended with data created by each acoustic source 232. The blended data stream may then be deblended during post processing to determine data streams that are specific to each acoustic source 232. The preceding description provides various examples of the systems and methods of use disclosed herein which may contain different method steps and alternative combinations of components.

Statement 1. A system for synchronizing a data stream may comprise one or more acoustic sources, an information handling system disposed on a platform, a GPS module connected to the information handling system, wherein the GPS module is configured to communicate with one or more global positioning system (GPS) devices, and a fiber optic cable connected to the information handling system.

Statement 2. The system of statement 1, wherein the GPS module comprises a time-code generator connected to the fiber optic cable.

Statement 3. The system of statement 2, wherein the GPS module comprises one or more optical phase modulators that modulate one or more optical signals in response to generation of location information by the GPS module.

Statement 4. The system of statements 1 and 2, wherein the GPS module comprises a time-code generator that generates time-codes.

Statement 5. The system of statement 4, wherein the GPS module comprises one or more time-code generators, and one or more fiber optic phase modulators modulate one or more optical signals in response to generation of the time-codes by respective ones of the time-code generators.

Statement 6. The system of statement 5, wherein the one or more fiber optic phase modulators modulate the one or more optical signals in response to generation of location information by the GPS module.

Statement 7. The system of statement 6, wherein the one or more GPS devices transmits the location information to the GPS module.

Statement 8. The system of statements 1, 2, and 4, wherein the information handling system controls initiation of vibration from the one or more acoustic sources, and wherein the information handling system is in communication with at least one time-code generator.

Statement 9. The system of statements 1, 2, 4, and 8, further comprising one or more fiber optic cables which transmit one or more optical signals at least partially to the information handling system.

Statement 10. The system of statements 1, 2, 4, 8 and 9, wherein the one or more acoustic sources are disposed on one or more boats.

Statement 11. The system of statements 1, 2, 4, and 8-10, wherein the one or more acoustic sources comprise an explosive source or originate from a vehicle.

Statement 12. The system of statements 1, 2, 4, and 8-11, wherein the one or more acoustic sources transmit one or more acoustic waves which are sensed by the fiber optic cable to determine at least one parameter characteristic of a seismic event.

Statement 13. A method of synchronizing a data stream may comprise transmitting one or more acoustic waves from one or more acoustic sources, sensing the one or more acoustic waves with a fiber optic cable to form a data stream, sending the data stream to an information handling system through the fiber optic cable, communication a time and a location to a GPS module attached to the information handling system with one or more global positioning system (GPS) devices, and modulating the time and the location to the data stream with a fiber optic phase modulator.

Statement 14. The method of statement 13, wherein the GPS module comprises a time-code generator connected to the fiber optic cable.

Statement 15. The method of statement 13 and 14, wherein the GPS module comprises a time-code generator that generates time-codes.

Statement 16. The method of statement 15, wherein the GPS module comprises one or more time-code generators, and the fiber optic phase modulator modulates one or more optical signals in response to generation of the time-codes by respective ones of the time-code generators.

Statement 17. The method of statement 16, modulating the one or more optical signals in response to generation of respective location information by the GPS module with the fiber optic phase modulator.

Statement 18. The method of statements 13-15, initiating vibration from a mechanical acoustic source with the information handling system, and wherein the information handling system is in communication with at least one time-code generator.

Statement 19. The method of statements 13-15 and 18, further comprising transmitting optical signals at least partially to the information handling system through the fiber optic cable.

Statement 20. The method of statements 13-15, 18, and 19, wherein the one or more acoustic sources are disposed on one or more boats.

Statement 21. The method of statements 13-15 and 18-20, wherein the one or more acoustic sources comprise an explosive source or originate from a vehicle.

Statement 22. The method of statements 13-15 and 18-21, further comprising sensing one or more acoustic waves with the fiber optic cable to determine at least one parameter characteristic of a seismic event.

It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces. Furthermore, it is implied that “acoustic” is synonymous with “seismic”.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only, and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A system for synchronizing a data stream comprising:
one or more acoustic sources;
an information handling system disposed on a platform;
a GPS module connected to the information handling system, wherein the GPS module is configured to communicate with one or more global positioning system (GPS) devices; and
a fiber optic cable connected to the information handling system.

2. The system of claim 1, wherein the GPS module comprises a time-code generator connected to the fiber optic cable.

3. The system of claim 2, wherein the GPS module comprises one or more optical phase modulators that modulate one or more optical signals in response to generation of location information by the GPS module.

4. The system of claim 1, wherein the GPS module comprises a time-code generator that generates time-codes.

5. The system of claim 4, wherein the GPS module comprises one or more time-code generators, and one or more fiber optic phase modulators modulate one or more optical signals in response to generation of the time-codes by respective ones of the time-code generators.

6. The system of claim 5, wherein the one or more fiber optic phase modulators modulate the one or more optical signals in response to generation of location information by the GPS module.

7. The system of claim 6, wherein the one or more GPS devices transmits the location information to the GPS module.

8. The system of claim 1, wherein the information handling system controls initiation of vibration from the one or more acoustic sources, and wherein the information handling system is in communication with at least one time-code generator.

9. The system of claim 1, further comprising one or more fiber optic cables which transmit one or more optical signals at least partially to the information handling system.

10. The system of claim 1, wherein the one or more acoustic sources are disposed on one or more boats.

11. The system of claim 1, wherein the one or more acoustic sources comprise an explosive source or originate from a vehicle.

12. The system of claim 1, wherein the one or more acoustic sources transmit one or more acoustic waves which are sensed by the fiber optic cable to determine at least one parameter characteristic of a seismic event.

13. A method of synchronizing a data stream comprising:
transmitting one or more acoustic waves from one or more acoustic sources;
sensing the one or more acoustic waves with a fiber optic cable to form a data stream;
sending the data stream to an information handling system through the fiber optic cable;
communication a time and a location to a GPS module attached to the information handling system with one or more global positioning system (GPS) devices; and
modulating the time and the location to the data stream with a fiber optic phase modulator.

14. The method of claim 13, wherein the GPS module comprises a time-code generator connected to the fiber optic cable.

15. The method of claim 13, wherein the GPS module comprises a time-code generator that generates time-codes.

16. The method of claim 15, wherein the GPS module comprises one or more time-code generators, and the fiber optic phase modulator modulates one or more optical signals in response to generation of the time-codes by respective ones of the time-code generators.

17. The method of claim 16, modulating the one or more optical signals in response to generation of respective location information by the GPS module with the fiber optic phase modulator.

18. The method of claim 13, initiating vibration from a mechanical acoustic source with the information handling system, and wherein the information handling system is in communication with at least one time-code generator.

19. The method of claim 13, further comprising transmitting optical signals at least partially to the information handling system through the fiber optic cable.

20. The method of claim 13, wherein the one or more acoustic sources are disposed on one or more boats.

21. The method of claim 13, wherein the one or more acoustic sources comprise an explosive source or originate from a vehicle.

22. The method of claim 13, further comprising sensing one or more acoustic waves with the fiber optic cable to determine at least one parameter characteristic of a seismic event.
